(19) United States
(12) Patent Application Publication
(10) Pub. No.: US 2014/0362427 A1
(43) Pub. Date: Dec. 11, 2014

(54) PROJECTION HEAD FOR A LASER PROJECTOR

(71) Applicant: LDT Laser Display Technology GmbH, Jena (DE)

(72) Inventor: Wolfram BIEHLIG, Jena (DE)

(21) Appl. No.: 14/465,672

(22) Filed: Aug. 21, 2014

Related U.S. Application Data
(63) Continuation of application No. PCT/EP2013/053241, filed on Feb. 19, 2013.

(30) Foreign Application Priority Data
Feb. 21, 2012 (DE) 10 2012 202 636.3

(51) Int. Cl. G02B 26/12

(52) U.S. Cl. CPC G02B 26/124
USPC 359/219.1

(57) ABSTRACT

A projection head is provided that has a fiber output coupling. A position of a point of intersection is able to be set between the light beams and thereby it is possible to position the point of intersection on the polygon facets. As a result, lower losses of light occur and edge discolourations during projection are reduced. The distance between the fibres can be chosen to be small (approximately 25-125 μm). It now also becomes possible to incorporate more than two fibres, as a result of which a plurality of lines can be scanned simultaneously.

This nonprovisional application is a continuation of International Application No. PCT/EP2013/053241, which was filed on Feb. 19, 2013, and which claims priority to German Patent Application No. 10 2012 202 636.3, which was filed in Germany on Feb. 21, 2012, and which are both herein incorporated by reference.

### BACKGROUND OF THE INVENTION

1. Field of the Invention

The invention relates to a fiber outcoupling with small fiber distances, therefore a new concept that improves the optical properties of the projection head in a scanning laser projection. For this purpose, a fiber outcoupling is presented which affords advantages over previous solutions with a fiber duo. It represents a possibility of being able to set the position of the intersection point between the light beams. Thus, it is possible to place the intersection point on the polygon facets. As a result, there are lower losses of light and edge discolorations during projection are reduced. The distance between the fibers is small (about 25-125 μm). As a result, it now becomes possible to incorporate more than two fibers, so that a plurality of lines can be scanned simultaneously. This enables a higher image resolution than can be realized hitherto with a fiber duo.

2. Description of the Background Art

In a laser projection the light is transported from a laser source to a projection channel via an optical fiber. The image quality is determined in this case decisively by the optics design in the area between the ends of the fiber duo and a two-axis scanner. The divergent light beams emerging from both light fibers are collimated by a collimating lens. Because of the distance of the fiber duo, different points of impact on the polygon result simultaneously. This beam displacement leads to a degradation of the image quality. In particular, the inhomogeneity of the brightness distribution in the image intensifies. In addition, edge discolorations can occur. The diaphragm eliminates a major part of the scattered light.

Such a known arrangement of the implementation of the fiber outcoupling for a fiber duo according to the state of the art is shown in FIG. 1. In the laser projector, the light is transported from the laser source to the projection channel via optical fibers 100, 101. The divergent light beams exiting the two optical fibers 100, 101 are collimated by a collimating lens 102. At the same time, different points of impact on the polygon facet mirror 104 result due to the lateral distance of fibers 100, 101 in the fiber duo.

DE 10 2004 001 389 A1 discloses an arrangement and a device for minimizing edge discolorations in video projectors. In this regard, an image made up of pixels is projected onto a projection surface. The arrangement comprises at least one light beam-emitting, variable-intensity light source and an adjustment device, downstream of a fiber and containing an optical delay for symmetrizing the light beam, and a subsequent deflection unit.

The method and device for projecting an image onto a projection surface from DE 10 2008 063 222 A1 are based on a fiber from DE 10 2004 001 389 A1 and propose constructing the deflection device with a scanner unit and suitable deflection mirrors. Further, the deflection unit comprises fixedly or movably arranged dichroic mirrors, etc., and optionally a diaphragm system.

DE 10 2007 019 017 A1, which corresponds to US 20100188644, discloses a further method and a further device for projecting an image, made up of pixels, onto a projection surface with at least one light beam-emitting, variable-intensity light source and an outcoupling unit downstream of the fiber and a subsequent deflection unit, which directs the light beam onto the projection surface.

DE 41 40 786 A1, which corresponds to U.S. Pat. No. 5,136,675, concerns a projection system in which narrow fiber bundles are used for the optical connection between the light source and projector. The light beams emitted from the individual fibers are imaged via an optic on the projection screen. Different image contents can be blended by an optical element for beam coalescence. The structure of the optics is not explained in greater detail.

DE 601 24 565 T2, which corresponds to U.S. Pat. No. 7,102,700, presents a raster laser projection system, in which closely adjacent fiber optic bundles are used, to be able to scan a plurality of lines simultaneously on the projection screen. The fiber ends are imaged by an optic onto the projection screen. The different primary color components (red, green, blue) are carried by different optical fibers. So that all color hues can be produced, the colored light spots (red, green, blue) must be superimposed on the projection surface. Three or more optical fibers are used for this purpose. One or more points on the projection surface must be irradiated one after the other or simultaneously by different scans within an image, so that a superposition of the light spots, which emerge from the different optical fibers of the fiber bundle, occurs on the projection surface. The possible structure of the optic downstream of the fiber is not described in greater detail.

### SUMMARY OF THE INVENTION

It is therefore an object of the invention to improve the properties of a projection head with a simple structure, so that the image quality is improved.

The problem of image improvement can be overcome in a first idea by enlargement of the polygon facet. The enlargement, however, would result in much higher costs and possibly limit the realizability of the polygon facets with sufficient quality.

The invention is therefore based on the idea of crossing collimated beams at the polygon facet mirror (intersection point), whereby the diaphragm is brought into a better position, without the functionality being negatively affected in any way. To this end, the known collimating lens is replaced by a new outcoupling system or outcoupling unit.

In a first variant, the system is formed by two converging lenses. The first converging lens produces a focal point of the two light beams in the vicinity of the focal plane of the second converging lens, which collimates them. The two light beams cross in the focal plane of the first converging lens. This intersection point is imaged by the second converging lens in the plane of the polygon facet, where then a second intersection point is located. The diaphragm is located at the first intersection point. In this regard, the system must be dimensioned so that an intersection point of the two light beams is located at the polygon facet mirror. The angle formed by the two light beams with one another and the beam diameter at the projection screen, in contrast, preferably remain unchanged. Because the system is not limited to a fiber duo, more than two fibers can also be used.

The advantage of this outcoupling unit is that the distance between the fibers can be selected as small (i.e., they lie closely adjacent to one another) (about 25-125 μm), so that now also more than two fibers can be incorporated, as a result of which a plurality of lines can be scanned simultaneously.

In a further variant, the system can be made up of converging and diverging lenses. Each fiber has a converging lens, which creates a virtual focal point in the focus of a diverging lens. The collimation is realized in the second step by the diverging lens. Upstream of the diverging lens, there is preferably a slight tilting of the beams emerging from the (two) fibers with respect to the optical axis.

A third variant results with the addition of a telescope. Even the overall length can be reduced as a result. As in the second variant, collimation occurs via the diverging lens, whereby the beam diameter is now smaller immediately thereafter and the tilt angle is greater. The telescope then broadens the beam and reduces the tilt angle to the required values. As a result, a plurality of optical fibers can be incorporated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a fiber outcoupling for a fiber duo according to the state of the art;

FIG. 2 shows a schematic diagram of the outcoupling optics of the invention with two fibers;

FIG. 3 shows an illustration with a plurality of fibers;

FIGS. 4a-c show an illustration of different fiber arrangements;

FIG. 5 shows a sketch-like illustration of a projected image;

FIG. 6 shows a possible realization of the arrangement in the form of a fiber array.

### DETAILED DESCRIPTION

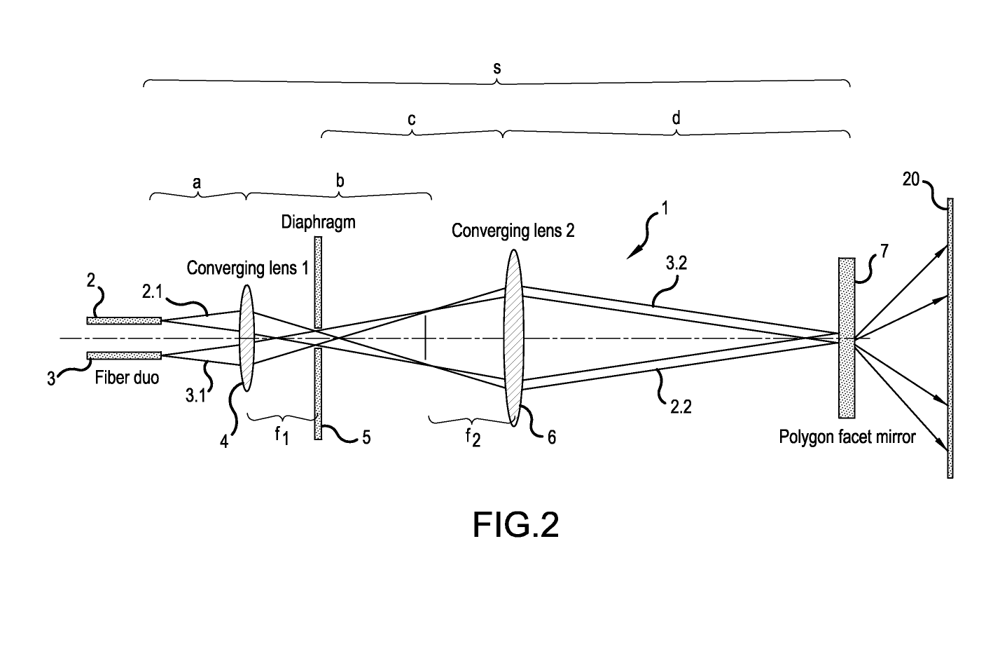

FIG. 2 shows outcoupling optics 1 (outcoupling system or also outcoupling unit) for two fibers 2, 3. The number 4 designates a first converging lens, here a focusing lens, and 5 a diaphragm. Placed downstream of diaphragm 5 is a second converging lens 6, here a collimating lens, which is spaced apart from a polygon facet mirror 7, which is followed by a projection screen 20. From fibers 2, 3, light beams 2.1 and 3.1 of a light source, which is not described in greater detail (and is variable in intensity), are outcoupled by converging lens 4 and via diaphragm 5 and second converging lens 6. First converging lens 4 thereby creates a focal point of the two light beams in the focal plane or in the vicinity of second converging lens 6, which collimates them. The two light beams cross in the focal plane of first converging lens 4. This intersection point is imaged by second converging lens 6 in the plane of polygon facet mirror 7, where a second intersection point is located. Scattered light diaphragm 5 is located at the first intersection point. Light beams 2.2, 3.2 crossed by polygon facet mirror 7 are imaged onto projection screen 20.

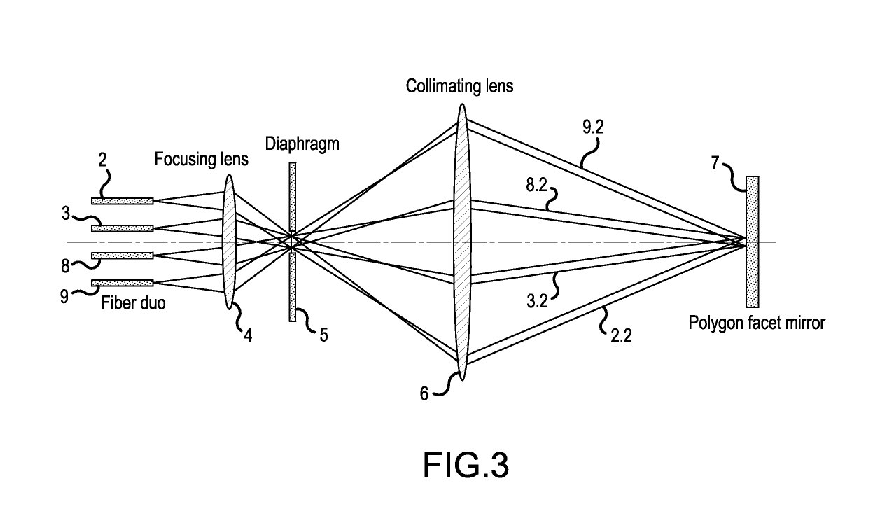

FIG. 3 shows the use of a fiber group 10 having four fibers 2, 3, 8, 9.

Each lens 2, 3, 8, 9 is in practice representative of a lens group. As already shown in FIG. 2, fibers 2, 3, 8, 9 can be oriented parallel to one another, which enables a small distance of fibers 2, 3, 8, 9 relative to one another and thereby makes possible a small installation space.

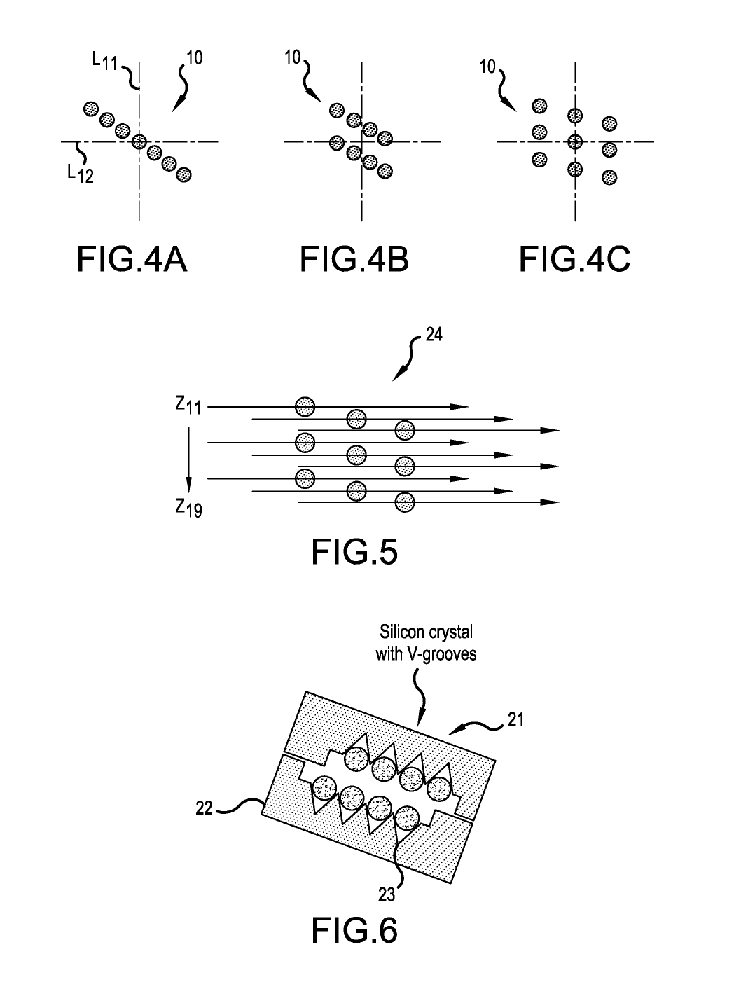

A wide variety of different possible realizations of fiber group 10 is conceivable. Thus FIG. 4(a-c) shows different arrangements of fiber group 10 in the viewing direction of the optical axis. The optical axis is located at the intersection point of the two lines L₁₁, L₁₂. Shown in each case are the fiber end surfaces of the fibers oriented parallel to one another. In this regard, the fiber arrangement must be realized so that each fiber produces a row Z₁₁ in the scanned image. Rows Z₁₁₋₁₉ are written equidistant and the row distances produce a defined value. In projected image 24 according to FIG. 5, arrangement 4c is imaged in a similar manner.

As is generally known, the requirements for production tolerances are high. Fibers must be arranged very accurately with respect to position and angle (tolerable distance error of about 0.5-2 μm). Fiber arrays 21 can be realized with a high precision, e.g., silicon plates 22 (or glass) with parallel V-grooves 23, as FIG. 6 shows. An optical fiber can then be inserted with great precision in each groove.

Outcoupling 1 is to be dimensioned so that there is an intersection point of the light beams at polygon facet mirror 7, whereby the beam diameter on projection screen 20 or on polygon facets 7 remains unchanged here in comparison with the prior art. In other words, the outcoupling during use of the same optical fibers on the projection screen and on the facets of the polygon mirror should have the same beam diameter as in the prior art. The distance of converging lenses 4, 6 itself can be determined with the aid of Newtonian imaging equations, etc.

The total length can be calculated according to the relationship

$$s = a + b + {f}_{2} + d = \frac{f ( f + 2 {f}_{2} ) + {d}^{2}}{d - {f}_{2}} ,$$

where:

a is the distance of the fiber end surfaces to converging lens 1,

b is the distance of converging lens 4 to focal point f₂,

c is the distance of focal point f₁ (diaphragm) to converging lens 2,

d is the distance of converging lens 6 to polygon facet mirror 7,

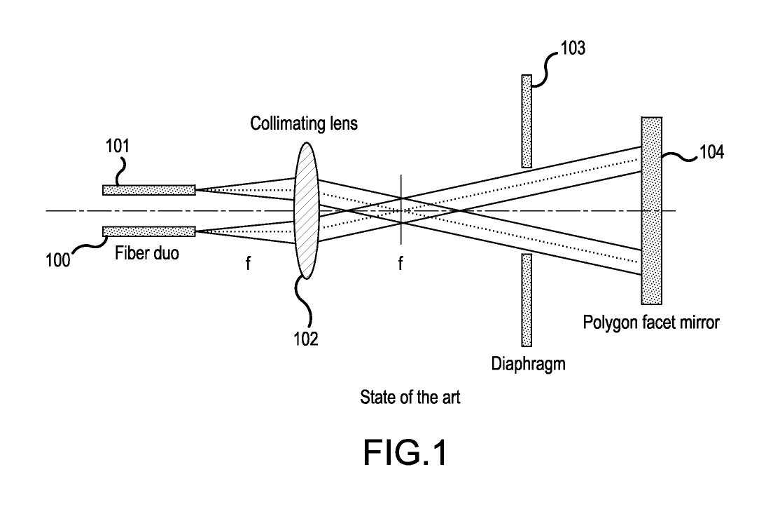

f is the focal length of the system to be replaced (FIG. 1),

f₁, f₂ are the focal lengths of the two converging lenses 4, 6 in FIG. 2,

s is the total length from the fiber end to the polygon.

The angle between the light beams on projection screen 20 is determined as

$$α = arctan ( \frac{e}{f} ) ,$$

where “e” is the lateral distance between optical fibers 2, 3 (8, 9).

The other two variants are not discussed further, because it is assumed that a structure of this type is easily explained as such. Based on the basic functionality of converging lenses and a diverging lens, each fiber has a converging lens, which creates a virtual focal point in the focus of the subsequent diverging lens. The collimation is then realized in the second step by the diverging lens and this is projected onto the polygon facet mirror. The fibers are tilted to one another such that the beams emerging from the fibers are tilted slightly relative to the optical axis and cross at the virtual intersection point.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A projection head for a laser projector, comprising:
a light source emitting a light beam;
a polygon facet mirror; and
an outcoupling unit arranged downstream of fibers, the fibers being slightly spaced apart and collimated beams being crossed by the outcoupling unit at the polygon facet mirror.

2. The projection head according to claim 1, wherein the outcoupling unit has a first converging lens as a focusing lens and a second converging lens, spaced apart from the first converging lens, as a collimating lens.

3. The projection head according to claim 2, wherein a diaphragm is arranged between the first and second converging lenses.

4. The projection head according to claim 2, wherein first and second converging lenses are formed by a lens group.

5. The projection head according to claim 1, wherein the fibers form a fiber group, which is placed in a fiber array.

6. The projection head according to claim 5, wherein the fiber array is formed by silicon plates with parallel V-grooves, and wherein each groove takes up an optical fiber.

7. The projection head according to claim 5, wherein the arrangements of the fiber group in a viewing direction of an optical axis are selected so that the optical axis lies at an intersection point of two lines of the fiber group.

8. The projection head according to claim 1, wherein a distance between the fibers is approximately between 25-125 μm.

9. The projection head according to claim 1, wherein the outcoupling unit has at least one converging lens for each fiber and has a diverging lens.

10. The projection head according to claim 9, wherein the outcoupling unit comprises a telescope arranged after the diverging lens.
